(19) United States
(12) Patent Application Publication
(10) Pub. No.: US 2005/0175745 A1
(43) Pub. Date: Aug. 11, 2005

(54) Method of preservation of a food prodcut and composition comprising one or more phytosterols and/or phytostanols useful for this purpose

(76) Inventor: Jerzy Zawistowski, Port Moody (CA)

Correspondence Address: SUSAN M. BEN-OLIEL;BARRISTER & SOLICTOR/PATENT AGENT, 2983 West 41 st Avenue, VANCOUVER, BC, V6N 3C8, CA

(21) Appl. No.: 10/772,416

(22) Filed: Feb. 6, 2004

(51) Int. Cl. C12H 1/10

(52) U.S. Cl. 426/321

(57) ABSTRACT

A method of preserving a food product from both deterioration due to microbial growth and oxidation of any constituent fats or oils which may be present within said food product comprises adding to the food product one or more phytosterols, phytostanols, or mixtures thereof.

### FIELD OF THE INVENTION

This present invention relates to the field of food preservation and the enhancement of character of foods which are not consumed immediately after manufacturing or processing.

### BACKGROUND OF THE INVENTION

Today, most food products are prepared and then require transportation and storage over long periods of time before purchase and ultimate use by the consumer. These food products may not always be stored under the most ideal conditions vis-à-vis temperature, humidity etc . . . in order to preserve the quality of the product and hence are subject to deterioration or spoilage. This deterioration or spoilage can be the result of microbiological contamination or various chemical reactions within the product.

Microbiological contamination may be the result of spoilage and/or pathogenic bacteria, viruses, yeasts or molds. For instance, some strains of Escherichia coli have been known for years to cause diarrhea in infants, and gastroenteritis in humans, associated with abdominal cramps, low-grade fever, nausea and malaise. Escherichia coli can be found in water, leading to food contamination. It is frequently isolated from dairy products and meats.

Salmonella spp, are Gram-negative bacteria widespread in poultry and swine, but the environmental sources of these organisms also include water, soil, insects, factory or kitchen surfaces, raw meats and seafoods, etc. They are responsible for salmonellosis, which is an intestinal infection that has been considered to be the most significant and notifiable food-borne illness in the world today.

Bacillus cereus is a Gram-positive bacterium incriminated in a wide variety of foods including meats, milk, vegetables, fish, and starchy foods. It causes diarrhoea, abdominal cramps, pain and nausea.

Listeria monocytogenes is particularly dangerous to pregnant women and elderly people. The manifestations of this Gram-positive bacterium include septicaemia, meningitis, encephalitis, or intrauterine or cervical infections it pregnant women. This psychtroph may be found in foods such as raw milk, cheeses, ice cream, raw vegetables, raw meats, fermented raw-meat sausages, etc. Its' ability to grow at temperatures as low as 3° C. permits multiplication in refrigerated foods.

Both pathogenic and spoilage bacteria can occur in raw food materials, but heat processing tends to reduce bacterial loads dramatically. After processing, most foods are at risk for recontamination prior to packaging, distribution, and final consumption, when they may be exposed to pathogens in the food handling environment. Even in the cleanest processing facilities, selected pathogens may contaminate the already processed foods, usually at very low levels. In the case of cold tolerant pathogens and psychotrophs, primarily various listerial species, they may then grow unchecked on the food during distribution and storage until final consumption. The more such pathogens grow in a food product, the higher the risk of infection among consumers of that food product.

This is a special concern for ready to eat meats and dairy products, as such foods are not heated or processed again by the user prior to consumption. In such cases, the most likely risk is from Listeria species that grow well under refrigeration. Consumption of elevated levels of any pathogen is recognized to increase the risk of infection, especially among infants, the elderly, pregnant women, and any immune compromised individuals. In 1998, it is estimated that there were approximately 500 deaths in the U.S. caused by listeriosis presumably contracted from foods.

In addition, trends toward shorter cooking times, consumer demand for safety, and willingness to use litigation are increasing the pressure on the food industry to reduce risks in the food chain. To combat this problem, food manufacturers have attempted to include anti-microbiological agents during or after food processing.

Commercial acetic acid, acetates, and more specifically sodium acetate, as produced from gas or oil, are known as having antimicrobial properties against many foodborne pathogens, especially against Salmonella spp and Escherichia coli particularly when used in combination with primary hurdles such as temperature and/or high acidity. However, these compounds are less effective when they are used as a primary hurdle against microorganisms such as Listeria monocytogenes, lactic acid bacteria, yeast and molds.

The preservative properties of acetic acid and salts of acetic acid in foods are described in the literature. In particular, U.S. Pat. No. 5,811,147 relates to a food and beverage preservative comprising a calcium component dissolved in a fermented solution of vinegar, alcohol, and a fermenting agent. U.S. Pat. No. 5,431,940 relates to a process for preparing noncarbonated beverage products with improved microbial stability which comprises mixing of a preservative (chosen from the group consisting of sorbic add, benzoic acid, alkali metal salts thereof and mixtures thereof, fruit juice, polyphosphates and water. The process alms to control microbial growth in noncarbonated diluted juice beverages.

In 1992 and 1993, U.S. Pat. Nos. 5,096,718 and 5,260,061 disclosed the use of metabolites of propionic acid bacteria in certain foods to increase the shelf life of treated food products. These metabolites demonstrate enhanced efficacy against gram negative bacteria but, unfortunately, are not effective against gram positive bacteria. U.S. Pat. No. 5,217,950 suggested the use of nisin compositions as bactericides. U.S. Pat. Nos. 5,573,797; 5,593,800 and 5,573,801 disclose antibacterial compositions which include a combination of a Streptococcus or Pediococcus derived bacteriocin or synthetic equivalent antibacterial agent in combination with a chelating agent. The composition is applied to the surface of the food to be treated either by direct application or by incorporating the composition onto a flexible film casing which is placed into intimate contact with the food surface. U.S. Pat. No. 5,458,876 suggests the combination of an antibiotic (such as nisin) with lysozyme as an antibacterial. In this case, lysozyme breaks down the cell wall and weakens the structural integrity of the target cell so that the antibacterial agent becomes more effective in damaging or killing the bacterial cell. U.S. Pat. No. 5,286,506 discloses the use of the fat soluble beta acids extract of hops for their bacteriostatic effects against Listeria monocytogenes in foods at 6 to 50 ppm by weight of the food. In addition, U.S. Pat. Nos. 5,370,863 and 5,455,038 suggest that certain hops acid derivatives that are chemically hydrogenated may have antibacterial activity against Listeria species.

The problem of microbiological contamination is particularly pronounced in the meat industry. Meats are easily contaminated with microorganisms and are an ideal environment for growth of bacteria. Pathogens such as Salmonella, Campylobacter, Listeria, Clostridium, Escherichia coli O157:H7, and the like can be present, Salmonella and Campylobacter jejuni are the leading causes of bacterial diarrhea. Listeria ingestion results in a high mortality rate. Escherichia coli O157:H7, familiar to many from news reports, is also particularly s vere and the number of incidences is increasing.

The time between the initial opportunity for bacterial contact with meat products and the ultimate consumption of such products by consumers, allows for the proliferation of these various forms of bacteria, some spoilage, some pathogenic. The growth of undesired bacteria on meat not only presents health concerns but aesthetic concerns affecting the marketability of meat products. For example, growth of spoilage bacteria creates undesired odors due to bacterial production of certain esters, hydrogen sulfide, nitrogenous compounds, futuric acid, propionic acid, formic acid, as well as other undesirable gases and acids. The growth of other such bacteria also acts to discolor the surface of the meat. Moreover, when meat packaged in permeable plastic packages spoils, the packaging often inflates due to the generation of gas produced by spoilage bacteria.

In late 1992 and early 1993, a very large outbreak of E. coli O157:H7 infections occurred in Washington and several other western states. More than 500 confirmed infections in four states occurred, with 61 cases of emolytic uremic syndrome (HUS), and four deaths. This outbreak, traced to undercooked hamburgers served at multiple outlets of the same fast food chain (Centers for Disease Control and Prevention [1993] Update: Multistate Outbreak of Escherichia coli O157:H7 infections from Hamburgers—Western United States, 1992-1993, Morbidity Mortality Weekly Report, 42:258-263) placed food safety, and E. coli O157:1H7 in particular, into public, industrial, and regulatory prominence.

Subsequently, there has been recognition of “new” vehicles for E. coli O157:H7 including some foods not traditionally associated with enteric infections, such as dry-cured salami and lettuce (Tarr, P. I. et al., [1997], “Verotoxigenic Escherichia coli infection: U.S. overview,” J. Food Protection 60:1466-1471) verifying the hardiness of this bacteria.

Furthermore, analysis of foods associated with outbreaks of E. coli O157:H7 reveals that the infective dose is low, perhaps less than a few hundred cells (Centers for Disease Control and Prevention [1995], “Surveillance for outbreaks of Escherichia coli O157:H7 infections-preliminary summary '94, Surveillance Summary No. SS-5”). Additional evidence for a low infectious dose is the capability for person-to-person transmission of E. coli O167:H7 infection. This combination of factors rates E. coli O157:H7 as most serious of known food borne pathogens.

The primary source of O157-H7 infection is through beef products, most commonly undercooked ground beef (Boyce, T. G. et al. [1995] “Current Concepts: Escherichia coli O157:H7 and the hemolytic uremic syndrome,” The New Eng. J. Med. 333:364-368).

The approach of the meat industry in addressing the problem of pathogenic bacteria has been multi-faceted. The US Food Safety and Inspection Service (FSIS)-approved antimicrobial treatments include hot water, steam and organic acids, such as lactic acid (up to 2.5%). The use of organic acids, such as lactic acid, or chlorine for decontamination of carcasses has been extensively studied because they reduce bacterial counts and are safe. One of the main drawbacks of organic acid sprays is that high concentrations of the acids lead to a loss of sensory quality. In addition, discoloration and the threshold for tasting the acid commences at about two percent.

Freezing food, and particularly meat, has proven to be an effective way in which to retard the growth of some bacteria that may be present on the surface of the food. The freezing of meat, however, especially for extended periods of time, has many undesirable effects. By freezing a meat product, water within the meat crystallizes, causing the denaturing of proteins and other damage to the meat on a cellular level. Moreover, the texture, consistency and taste of thawed frozen meat is less desirable than that of fresh meat.

Additional techniques have been developed in attempts to destroy surface bacterial flora on meat. For example, U.S. Pat. No. 4,852,216 to Clayton discloses a disinfection system using an acetic acid spray in order to reduce bacterial levels and thereby increase shelf life of meat products. U.S. Pat. No. 3,924,044 to Busch discloses a method for applying a hot, dilute acid solution to meat surfaces to destroy psychotropic spoilage bacteria on meat surfaces.

U.S. Pat. No. 3,991,218 teaches the encapsulation of meat products in a film of alginate material to retard the growth of anaerobic bacteria on the surface of the meat.

Food products having an extended shelf life afford more time in which handlers, shippers, and wholesalers can transport and sell such food before spoilage occurs. Efforts to increase the shelf life of food products, such as meat, have traditionally, as discussed above, been focused on reducing the number of bacteria present on the surface of the food.

Microbial spoilage of food products, while of critical importance, is not the only problem that needs to be addressed in the field of food manufacture, transport and use. Food products which contain oils and fats are prone to significant oxidation during storage in the presence of air (and particularly at elevated temperatures) and during cooking.

In light of the above problems, there exists a need in the art for a method for treating foods with anti-microbial compositions that are active at reasonable usage levels in common food applications and that are non-toxic to humans, even at high levels. More specifically, there exists a need for effective treatments that can be conveniently integrated into existing processing protocols for these products. Furthermore, a need exists for a method for preserving food products, particularly fresh meat and meat by-products, by selectively reducing the number of spoilage and pathogenic bacteria present in and on such food products.

It is an object of the present invention to address these needs and to obviate or mitigate the problems described herein.

### SUMMARY OF THE INVENTION

The present invention provides a method of preserving a food product from both deterioration due to microbial growth and oxidation of any constituent fats or oils which may be present within said food product, which comprises adding to the food product one or more phytosterols, phytostanols, or mixtures thereof.

The present invention further provides a food product comprising an anti-microbiologically effective amount of one or more phytosterols, phytostanols, or mixtures thereof.

In another aspect, the present invention provides a method of reducing the microbial contamination of a particulate food material which comprises mixing into or forming said food material with an anti-microbially effective amount of one or more phytosterols, phytostanols, or mixtures thereof.

In yet another aspect, the present invention provides a prepared food product comprising one or more phytsterols, phytostanols or mixtures of both, wherein said food product, after the processing steps to prepare the product and during storage before consumption, contains a reduced number of pathogenic and/or spoilage-causing microbes as compared to the same food product without phytosterols and/or phytostanols.

Surprisingly, it has been found that phytosterols and phytostanols exhibit multiple benefits with respect to the maintenance of food product quality. While each benefit individually is considered important, it is the combination of these effects which will impact the food industry most significantly. By way of this invention, there is provided a means to reduce microbial growth in food products by agents which are non-toxic, which are “naturally derived” and which do not negatively affect any of the organoleptic properties of the food product. Heretofore, phytosterols and phytostanols have not been appreciated in this function. At the same time as exhibiting these anti-microbial effects, the agents as described herein prevent or reduce the oxidation of any constituent fats or oils which may be present within said food product. Furthermore, when the food product comprises an emulsion, if has been found that phytosterols and/or phytostanols, present therein, significantly stabilize the emulsion from phase separation after production.

Additionally, some phytosterols have received a great deal of attention due to their ability to decrease serum cholesterol levels when fed to a number of mammalian species, including humans. There are even broader therapeutic advantages of phytosterols now recorded, not only in respect to the treatment of cardiovascular disease and its underlying conditions such as hypercholesterolemia, hyperlipidemia, atherosclerosis, hypertension, thrombosis but in the treatment and inhibition of other diseases such as Type II diabetes, dementia (including Alzheimer's disease), and cancer (including colon and prostate). Accordingly, there are significant ancillary benefits which accompany the anti-microbial function of the agents within food products.

These effects and other significant advantages will become apparent herein below.

### BRIEF DESCRIPTION OF THE DRAWINGS

FIG. 1 is bar graph showing the formation of malonaldehyde in oil during two days at 105° C. with oil being supplemented with either nothing (control); sterols, rosemary, or vitamin E;

FIG. 2 is a bar graph showing the disappearance of fatty acids in oil during 2 hours at 105° C. with oil being supplemented with either nothing (control); sterols, rosemary, or vitamin E;

FIG. 3 is a bar graph showing the disappearance of fatty acids in oil during 2 hours at 180° C. with oil being supplemented with either nothing (control); sterols, rosemary, or vitamin E; and

FIG. 4 is bar graph showing the formation of peroxide in oil during 5 hours at 180° C. with oil being supplemented with either nothing (control); sterols, rosemary, or vitamin E.

### PREFERRED EMBODIMENTS OF THE INVENTION

The following detailed description is provided to aid those skilled in the art in practising the present invention. However, this detailed description should not be construed so as to unduly limit the scope of the present invention. Modifications and variations to the embodiments discussed herein may be made by those with ordinary skill in the art without departing from the spirit or scope of the present invention. Unless otherwise defined, all technical and scientific terms used herein have the same meaning as commonly understood by one of ordinary skill in the art to which this invention pertains.

As used herein, “animal” means any member of the animal kingdom, including preferably humans.

As used herein, “food” or “food product” or “food material” means any safe, ingestible product for animal use, including human use, and includes “functional foods”, dietary supplements, nutraceuticals, natural health products and “designer foods”.

As used herein, “functional food” means a product that is similar in appearance to conventional foods that is consumed as part of a usual diet, but which has demonstrated physiological benefits and/or reduces the risk of disease.

As used herein, “designer food” has the same meaning as functional food.

As used herein, “nutraceutical” means a non-pharmaceutical product prepared in the form of pills, powders, potions and in other medicinal forms not generally associated with food but which has a physiological benefit or provides protection against disease.

Anywhere in the world, nutraceuticals, functional foods, natural health products, and designer foods may be food or food ingredients considered to provide medical or health benefits, including the prevention and treatment of disease.

As used herein, the terms “microbe” refers to any unicellular organism or multi-cellular parasitic organism that one of skill in the art chooses to reduce in food products and/or nutraceuticals. Microbe, unless otherwise indicated refers to both spoilage and pathogenic microbes.

As used here, the term “anti-microbial” refers to a compound, agent, treatment, method or effect that is biocidal (e.g. kills microbial cells or components of microbial cells), biostatic (e.g. prevents further growth of microbial cells), or a combination thereof. As such, “anti-microbially effective” refers to the amount of the compound, or agent described herein having one or more of the following effects: bacteriostatic, bactericidal, fungistatic, fungicidal, anti-parasitic and anti-viral.

As used herein, the term “phytosterol” includes all sterols without limitation, for example: sitosterol, campesterol, stigmasterol, brassicasterol (including dihydrobrassicasterol), desrnosterol, chalinosterol, poriferasterol, clionasterol, ergosterol, coprosterol, codisterol, isofucosterol, fucosterol, clerosterol, nervisterol, lathosterol, stellasterol, spinasterol, chondrillasterol, peposterol, avenasterol, isoavenasterol, fecosterol, pollinastasterol, and all natural or synthesized forms and derivatives thereof, including isomers. The term “phytostanol” refers to saturated or hydrogenated sterols including all natural or synthesized forms and derivatives thereof, and isomers. It is to be understood that modifications to the phytosterols and phtostanols i.e. to include side chains also falls within the purview of this invention. For example, the purview of this invention clearly includes 24 beta-ethylsitostanol, 24-alpha-ethyl-22-dehydrositostanol. It is also to be understood that, when in doubt throughout the specification, and unless otherwise specified, the term “phytosterol” encompasses both sterol and stanol. In a most preferred form, the sterol is in its saturated form and is a sitostanol, preferably beta-sitostanol.

These sterols and stanols for use in accordance with this invention may be procured from a variety of natural sources. For example, they may be obtained from the processing of plant oils (including aquatic plants) such as corn oil and other vegetable oils, wheat germ oil, soy extract, rice extract, rice bran, rapeseed oil, sunflower oil, sesame oil and fish (and other marine-source) oils. They may also be derived from fungi, for example ergosterol. Accordingly, the present invention is not to be limited to any one source of sterols. U.S. Pat. Ser. No. 4,420,427 teaches the preparation of sterols from vegetable oil sludge using solvents such as methanol. Alternatively, phytosterols and phytostanols may be obtained from tall oil pitch or soap, by-products of forestry practises as described, for example, in U.S. Pat. Ser. No. 5,770,749, incorporated herein by reference.

Phytosterols and phytostanols, as used herein, may be in their free form or in one or more of their esterified forms i.e. optionally, the phytosterol or phytostanol may be esterified prior to formation of the food products. This esterification step renders the phytosterols and/or phytostanols more soluble in fats and oils which may, in some instances, facilitate the incorporation of the phytosterols into various food products.

To form phytosterol and/or phytostanol esters, many methods are known in the art. For example, one or more suitable aliphatic adds or their esters with low boiling alcohols may be condensed with the selected phytosterol and/or phytostanol. A wide variety of aliphatic adds or their esters may be used successfully and include all aliphatic acids consisting of one or more alkyl chains with one or more terminal carboxyl groups. These aliphatic acids may be natural of synthetic and are represented by the following chemical formulae:
a) R1-COOH (monocarboxylic acid) wherein:
   R1 is an unbranched saturated alky group, represented by CH3-, CH3CH2- or CH3(CH2)nCH2- WHERE n=3-25; or
   R1 is a branched saturated alkyl group represented by CnH2n+1-where n-1-25 is the number of carbon atoms contained in the group R1; the branching typically refers, but is not limited to one or more methyl group side chains (branches); or
   R1 is an unbranched or branched unsaturated alkyl group, represented by the formula CnH2n−2 m+1, where n=1-25 is the number of carbon atoms in R1 and m=degree of unsaturation; or
b) HOOC—R2-COOH is a dicarboxylic acid wherein:
   R2 is an unbranched saturated alkyl group, represented by —CH2-, or —CH2CH2-, or —CH2(CH2)nCH2 where n=3-25; or
   R2 is a branched saturated alkyl group represented by —CnH2n- where n=1-25 is the number of carbon atoms contained in the group R2; the branching typically refers, but is not limited to, one or more methyl group side chains (branches); or
   R2 is an unbranched or branched unsaturated alkyl group, represented by the formula CnH2n−2m, where n=1-25 is the number of carbon atoms in R2 and m=degree of unsaturation; or
c) a tricarboxylic acid represented by the formula: 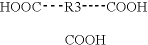
   wherein, in this formula:
   R3 is a branched saturated alkyl group represented by —CnH2n−1- where n=1-25 is the number of carbon atoms contained in the group R3; the branching typically refers, but is not limited to, one or more methyl group side chains (branches); or
   R3 is a branched unsaturated alkyl group, represented by CnH2n−2m−1- wherein n=1-25 is the number of carbon atoms in R3 and m=the degree of unsaturation; or
d) a mono-, di-, or tricarboxylic acid as defined above, which may contain one, two or three hydroxyl groups in the molecule.

In a preferred form, the acid is either a straight-chain or branched unsaturated or saturated, aliphatic or aromatic acid. More preferably, the acids are selected, inter alia, from the following list valeric acid, isovaleric acid, sorbic acid, isocaproic acid, lauric acid, myrestic acid, palmitic acid, stearic acid, caproic acid, ascorbic acid, arachidic acid, behenic acid, hexacosanoic add, octacosanoic acid, pentadecanoic acid, erucic acid, linoleic acid, linolenic acid, arachidonic acid, acetic acid, citric acid, tartaric acid, palmitoleic acid and oleic acid. The most preferable fatty adds within the scope of the present invention are linoleic add, linolenic acid and arachidonic acid which may be obtained from natural sources such as safflower oil, sunflower off, olive oil and corn oil (linoleic acid), safflower oil, sunflower oil, olive oil and jojoba oil (linolenic acid and arachidonic add) and rapeseed oil (erucic acid).

Other aromatic acids are clearly contemplated within the scope of the present invention.

If it is desired to esterify the phytosterols, one particular advantage in using fatty acids to form esterifed phytosterols or phytostanols i.e. saturated fats, in accordance with the present invention lies in the fact that saturated fats increase lipoprotein lipase activity. The activity of this latter enzyme reduces visceral fat formation.

By way of example, to form a phytosterol ester, the selected phytosterol and acid or its ester with volatile alcohol may be mixed together under reaction conditions to permit condensation of the phytosterol with the acid. A most preferred method of preparing these esters which is widely used in the edible fat and oil industry is described in U.S. Pat. Ser. No. 5,502,045 (which is incorporated herein by reference). As no substances other than the free phytosterol, a fatty acid ester or mixture thereof and an interesterification catalyst like sodium ethylate are used, the technique is highly suitable for preparing products ultimately for human consumption in overview, this preferred method, adapted for use within the present invention, comprises heating the phytosterol(s) with a vegetable oil fatty acid ester (preferably a methyl ester) at a temperature from 90-120° C. and subsequently adding a suitable catalyst such as sodium ethylate. The catalyst is then removed/destroyed by any one of the techniques known in the art e.g. adding water and/or filtration/centrifugation.

Another method which may be used in accordance with the present invention is described in U.S. Pat. Ser. No. 4,588,717, which is also incorporated herein by reference. A preferred method is to mix the phytosterol and the fatty acid together bringing the mixture to a temperature of from about 15° C. to about 45° C. at about atmospheric pressure for approximately one to three hours.

Accordingly, it is to be understood that the widest possible definition is to be accorded to the terms “phytosterol” and “phytostanol” as used herein, including, but not limited to: free phytosterols and phytostanols, esterified phytosterols and phytostanols with aliphatic or aromatic acids (thereby forming aliphatic or aromatic esters, respectively), phenolic acid esters, cinnamate esters, ferulate esters, phytosterol and phytostanol glycosides and acylated glycosides or acylglycosides. It is also to be understood that the term “phytostorols” as used herein, whether singular or plural, unless otherwise indicated, includes both phytosterols and phytostanols.

In a preferred form of the present invention, in order to maximize both the anti-microbial and antioxidant effects, the phytosterol component added to the food product is a combination of free sterols (and/or free stanols) and sterol esters (and/or stanol esters). Preferably, the phytosterol component comprises at least 10% by weight of free sterols. More preferably, the phytosterol component comprises from 10-75% by weight of free sterols. Balancing the free sterol vs. sterol ester moieties may also be optimally achieved with a 1:1 ratio. It is most important that consideration be given to balancing the free sterols and sterol esters as described herein in fat based food products and oils. In such applications, the use of 100% sterol esters is not preferred.

Methods of Use

The means by which the phytosterol is added to, or incorporated in or on the food product will depend largely on the specific type of food product. It is anticipated that such incorporation will occur at the time of manufacture of the food product, although in many cases, later addition may also be possible. Manufacture, with respect to fresh meat, fish and poultry applications, is understood to mean to all steps subsequent to slaughter in which the animals are fabricated into sections for use in the grocery and restaurant trade.

Phytosterols may be applied to or incorporated into various food products by spraying, injecting, dipping, painting, coating, tumbling, marinating, mixing, pumping, by or dispersion with a carrier or vehicle. These types of methods are particularly, but not exclusively, appropriate for meat, fish and poultry applications.

The incorporation of phytosterols into some food products may be complicated by the fact that they are highly hydrophobic and only dissolve in oils and fats to a limited extent. This may be addressed in a number of different ways, as outlined in detail in the art and including by grinding the phytosterols, wet or dry milling the phytosterols, reducing the particle size of the phytosterols (for example by microfluidization or micronisation), spray drying, lyophilizing, and esterifying the phytosterois.

Grinding or milling the phytosterols in order to enhance their solubility is described in U.S. Pat. Ser. Nos. 3,881,005 and 4,195,084 both to Eli Lilly. Esterification of phytosterols in order to enhance their solubility is described in German Patent 2035069/Jan. 28, 1971 (analogous to U.S. Pat. No. 3,751,569). There are numerous other patents and journal citations outlining a vast array of possible esterification processes.

PCT/CA00/00096 filed Feb. 3, 2000 to Forbes Medi-tech Inc., the contents of which are incorporated entirely by reference, teaches a method of preparing microparticles of phytosterols and/or phytostanols using impact forces thereby yielding uniform submicron particles which are highly suitable for incorporation into food products. It has been found that the phytosterols/stanols so prepared have greater solubility, not only in oil-based delivery systems but in other media and aqueous systems which opens the door for a vast array of options for the types of foods into which phytosterols may be mixed. Particle size of the phytosterols may be reduced by shear forces, wherein a semi-fluid, fluid or viscous vehicle comprising the dispersed or suspended phytosterols is forced through an air-atomization or pneumatic nozzle or microfluidizers. Particle size reduction may also be achieved by steep shearing gradients in high-speed stirrers or colloid mills.

Furthermore, when phytosterols and/or phytostanols are incorporated into a delivery vehicle or “base matrix” using microfluidization technology, this base matrix can then further be used easily and effectively to prepare a vast array of foods and beverages. For example, phytosterols and/or stanols may be incorporated at varying concentrations, but most preferably at concentrations up to 12%, into milk using microfluidizing technology thereby creating a stable dispersion. The milk so prepared is then a suitable base for making other products such as ice cream, cream for butter and cheeses and yoghurt and other dairy products. When the base matrix is fat like cocoa butter, the phytosterols an/or phytostanols may be incorporated therein using microfluidizing technology and subsequently used to make chocolate and other confections. When the base matrix is a fat or fat blend, for example comprising lard, lard flakes, palm oil, palm kernel oil, cottonseed oil, coconut oil, soybean oil, corn oil, rapeseed oil or the like, an emulsion is formed using the method of the present invention which subsequently can be used to prepare cereal bars. The uses of microparticulate phytosterols/stanols are nearly endless in food technology.

In addition, edible emulsions comprising phytosterols and/or phytostanols may be formed using the microfluidizing technology. For example, and as described further below, phytosterols and/or phytostanols can be emulsified into oils and fats and then subsequently used to produce dressings such as salad and vegetable dressings, mayonnaise, dairy and non-dairy spreads, chocolates and other confections and beverages.

In a preferred form, the incorporation of phytosterols and/or phytostanols into the base matrix or delivery vehicle is as follows: phytosterols and/or phytostanols in powder form, preferably of particle size around 100 um, are blended or suspended into the delivery-vehicle (for example, fats, oils or aqueous solutions as described above) using a batch mixer, preferably a high shear mixer such as T50 Ultra Turrex. Subsequently, the blend is forced into a microfluidizer interaction chamber using a pump or compressed air. Microfluidization is performed under pressure of 15,000 to 23,000 PSI, most preferably around 20,000 PSI. Several passes through the chamber may be required in order to achieve the preferred phytosterol/stanol particle size i.e. under 20 microns, most preferably in the range of 10-20 microns.

PCT/CA00/01298 filed on Nov. 3, 2000 to Forbes Medi-tech Inc., the contents of which are fully incorporated herein by reference describes a method of incorporating phytosterols and/or phytostanols into an edible oil or fat composition and in which these phytosterols or phytostanols are substantially completely dissolved, which comprises:
a) heating the phytosterols and/or phytostanols to form a molten material;
b) heating the edible oil or fat;
c) mixing the molten material with the heated edible oil or fat; and
d) cooling the composition so formed.

This method is very useful in the context of the present invention, in order to dissolve phytosterols in a fat-based or oil-based food matrix. A wide variety of edible oils and fats can be used in dissolving the phytosterols. This includes any food-grade oily or fat substance, of plant or animal or marine origin, or mixture thereof. Without limiting the generality of the foregoing, all salad and cooking oils, including sunflower oil, rapeseed oil, soybean oil, olive oil, corn oil, safflower oil, sesame seed oil may have phytosterols incorporated therein by this means. Oils obtained by directed low temperature interesterification or rearrangement of animal or vegetable fatty materials, followed by removal of higher melting solids may also be used.

The key feature of this melting-incorporation method is the actual heating of the phytosterols to form a molten material prior to mixing with the heated oil or fat. Generally, phytosterols/stanols may be heated to this molten condition at a temperature of from about 120° to 160° C., most preferably from about 135° to 140° C. The melting point of most phytosterols is about 138° C. This molten material so formed is then added to oil which has been previously heated to a temperature of from about 90° to 190° C., more preferably from about 100° to 120° C. The oil “composition” comprising the molten phytosterols is then cooled to room temperature. The resultant product is oil in which the phytosterols are and remain substantially completely dissolved at room temperature.

To assist in the incorporation into various food products, phytosterols may be solubilized or dispersed in emulsions, suspensions, solutions, solid dispersions, macroemulsions, microemulsions, self-emulsifying systems, hydrated lipid systems, formed into inclusion complexations with cyclodextrins or bile salts or formed into hydrotopes.

Prior to these solubility/dispersability enhancement techniques, it is preferred that the phytosterols and/or phytostanols be isolated from the source and formed into a solid powder through precipitation, filtration and drying, spray drying, lyophilization or by other conventional work-up techniques. This powder form may then be physically modified to enhance the solubility and dispersability of the phytosterol and/or phytostanol in the chosen delivery medium.

Incorporation of phytosterols into many food products is best achieved by the formation of emulsions. Phytosterols based emulsions may be prepared using microfluidizing technology as follows: the phytosterols and/or stanols are dispersed or suspended in an oil (or fluid) phase; the oil (or fluid) phase is then combined with a fluid or semi-fluid (or oil) phase along with an emulsifier and any optional ingredients such as a thickening agent etc . . . , to form a “blend”; the blend is then introduced into the microfluidizider at a pressure suitable to form and stabilize the emulsion. It is preferred that the oil phase comprises edible oils and fats, most preferably, vegetable oils. It is contemplated that many types of phytosterol-based-emulsions may be prepared using this process, including the formation of dairy and non-dairy spreads comprising one or more phytosterols and/or stanols.

Once such an emulsion is formed, it may be encapsulated in a carbohydrate shell by a further pass through the microfluidizer as follows: blending the emulsion described above with a solution or suspension comprising one or more carbohydrates, preferably complex carbohydrates such as polysaccharides (for example: starch, inulin, glycogen) and/or one or more simple sugars such as glucose, fructose and the like—an appropriate suspension is corn syrup) and introducing this blend so formed into a microfluidizer at a suitable pressure. After subsequent spray drying, the resultant product is a core of phytosterol and fat or oil encapsulated in an outer carbohydrate shell. This encapsulated product may then be used in food products.

The present invention provides, in one aspect, a method of preserving a food product from both deterioration due to microbial growth and oxidation of any constituent fats or oils which may be present within said food product, which comprises adding to the food product one or more phytosterols, phytostanols, or mixtures thereof.

In another aspect, the present invention provides a method of reducing the microbial contamination of a particulate food material which comprises mixing into or forming said food material with an anti-microbially effective amount of one or more phytosterols, phytostanols, or mixtures thereof.

In yet another aspect, the present invention provides a prepared food product comprising one or more phytsterols, phytostanols or mixtures of both, wherein said food product, after the processing steps to prepare the product and during storage before consumption, contains a reduced number of pathogenic and/or spoilage-causing microbes as compared to the same food product without phytosterols and/or phytostanols.

Microbes which are susceptible to the methods of the present invention include prokaryotic organisms, fungi and molds, and yeast. It is to be understood, however, that the focus of the present invention is clearly on foodborne microbes. Exemplary prokaryotic organisms include, but are not limited to, Bacillus, Campylobacter, Clostridium, Corynebacterium, Escherichia, Hemophilus (Haemophillus), H licobacter, Legionella, Listeria, Mycobacterium, Mycoplasma, Pseudomonas, Salmonella, Shigella, Staphylococcus, Streptococcus, Trypanosoma, Vibrio, and Yersinia (see, for example, the lists of microorganism genera provided at the Center for Disease Control website:http://ww.cdc.gov). Exemplary fungi which can be treated using the methods of the present invention include, but are not limited to, Actinomycetes, Aspergillus, Botrytis, Candida Cladosporium, Cryptococcus, Fusarium, Mucor, Neurospora, Penicillium, Rhizobium, Rhyzoctonia, Rhizopus, ringworm fungi (e.g., Microsporum, Epidermophyton and Trichophyton), Saccharomyces, and Streptomyces. Additional unicellular and/or parasitic organisms which can be reduced in population using the methods of the present invention include, but are not limited to, various algaes, slime molds, and water molds, as well as parasitic organisms such as Cryptosporidia, Giardia, Plasmodium, Toxoplamsa.

The methods of the present invention can also be employed to reduce one or more viral populations in a food product. Viruses which are susceptible to the methods and compositions of the present invention include, but are not limited to Hepatitis A and Norwalk virus (most likely calicivirus class) and the like. For a general review, see Dulbecco and Ginsberg Virology (reprinted from Davis, Dulbecco, Eisen and Ginsberg's Microbiology, third edition (1980) Harper and Row, Philadelphia, Pa.).

As used herein the term “shelf life” means the period of time that a food product remains saleable to retail customers. In traditional meat processing, the shelf life of fresh meat and meat by-products is about 30 to 40 days after an animal has been slaughtered Refrigeration of meat during this period of time largely arrests and/or retards the growth of pathogenic bacteria, and to a lesser extent, spoilage bacteria. After about 30 to 40 days, however, refrigeration is no longer able to effectively control the proliferation of spoilage bacteria below acceptable levels. Spoilage microbes present on meat products after this time period are able to assimilate proteins and sugars on meat surfaces and begin to generate undesired by-products. Spoilage microbes may also act to discolor meat, making such meat unappealing and undesirable for human consumption.

The term “spoilage microbe” as used herein refers to any type of microbe that acts to spoil food. Spoilage microbes may grow and proliferate to such a degree that a food product is made unsuitable or undesirable for human or animal consumption. Microbes are able to proliferate on food surfaces by assimilating sugars and proteins on such surfaces. By metabolizing these components, spoilage microbes, particularly bacteria, create by-products including carbon dioxide, methane, nitrogenous compounds, butyric acid, propionic acid, lactic acid, formic acid, sulfur compounds, and other undesired gases and acids. The production of such by-products alters the color of meat surfaces, often turning meat from a red color to a brown, grey or green color. Gaseous by-products generated by spoilage bacteria also give spoiled meat an undesirable odor. The color and odor alterations of meat due to the growth of spoilage bacteria on a meat product's surface often makes such meat unsatisfactory for sale to consumers.

In addition to the control of spoilage microbes, another significant concern in the food processing industry is controlling the growth of pathogenic microbes, including pathogenic bacteria. As used herein, the term “pathogenic microbe” refers to any food poisoning organism that is capable of causing disease or illness in animals or humans. The term pathogenic microbe will be understood to include bacteria that infect foods and thereby cause disease or illness, as well as bacteria that produce toxins that cause disease or illness. The proliferation of pathogenic bacteria on food products can cause severe illness and may be deadly, as demonstrated by the number of human fatalities caused by botulism. Both spoilage and pathogenic microbes are targeted by the method of the present invention.

Pathogenic and spoilage bacteria can be aerobic, anaerobic or facultative, and thus, the elimination of oxygen alone from a food package or from a food storage environment will not effectively eliminate all types of undesired bacteria. Moreover control of the temperature in the storage of food is not totally effective to preclude the growth of such bacteria because several types of pathogenic and spoilage bacteria are able to grow at various temperatures. While exposure to very high temperatures is known to be effective in killing most bacteria, such exposure may damage at least a portion of a food product by essentially cooking the food. High temperatures may also act to denature enzymes necessary for desired aging of some meat products. Moreover, certain pathogenic bacteria produce toxins that are not destroyed by exposure to elevated temperatures. Thus, raising the temperature of food is not a practical way in which to effectively eliminate the negative effects of pathogenic bacterial contamination of a food product.

Food Product

Food product includes any food that is susceptible to the effects of pathogenic microbe and/or spoilage microbe proliferation in or on the food and/or any food product which is prone or susceptible to oxidative deterioration. Such food products include, but are not limited to: meat, vegetables, fruits, grains and grain derived products, milk products, beer, fruit juices, dairy products, margarine and spreads (dairy and non-dairy), peanut and other butters, shortening, sauces, baked goods, fried snack products, confections and chocolate.

Accordingly, examples of food products which may be treated in accordance with the method of the present invention include:
1) Dairy Products—such as cheeses, butter, milk and other dairy beverages, spreads and dairy mixes, ice cream and yoghurt;
2) Fat-Based Products—such as margarines, yellow spreads, mayonnaise, shortenings, cooking and frying oils and dressings;
3) Meats-including from bovine, ovine, porcine, poultry, fish and crustaceous seafood;
4) Cereal-Based Products—comprising grains (for example, bread and pastas) whether these goods are cooked, baked or otherwise processed;
8) Confectioneries—such as chocolate, candles, chewing gum, desserts, non-dairy toppings (for example Cool Whip™), sorbets, icings and other fillings;
9) Beverages—dietary supplements and meal replacement drinks such as those sold under the trade-marks Boost™ and Ensure™; and
10) Miscellaneous Products—including eggs and egg products, processed foods such as soups, pre-prepared pasta sauces, pre-formed meals, potato chips, crackers and snack foods and the like.
   Meats

The method of the present invention is particularly useful in the treatment of meats. In the preparation of meat product, for animal or human consumption, one of the paramount concerns is to reduce the number of microbes, especially bacteria, present on the surface. The reason bacterial control on a food product is so important is that certain types of bacteria, namely pathogenic and spoilage bacteria, shorten the shelf life of meats by multiplying therein, thereby generating undesired by-products that cause malodors, discoloration or poisoning.

As used herein, the term “meat” refers to any fresh meat product or meat by-product from an animal of the kingdom Animalia which is consumed by humans or animals, including without limitation meat from bovine, ovine, porcine, poultry, fish and crustaceous seafood. Thus, while one use for the present invention relates to meat processed in the slaughtering of mammals in a meat processing facility or thereafter is other processing phases, it is to be expressly understood that the invention has application in the processing of other edible meat products including fish, poultry and seafood.

In the meat packing industry, many types of bacteria are known to cause food poisoning including: E. coli, Salmonella, F. coliforms, Listeria, Staphylococcus, F. streptococcus, Bacillus anthraces, Balantidium coli, Campylobacter coli, Campylobacter jejune, Francisella tularensis, Sarcocystis, Taenia saginata, Taenia solium, Toxoplasma gondil, Trichinella spiralis, Yersinia enterocolinee, Yersinia pseudotuberculosis, Brucella, Chlamydia petechia, Leptospira and Clostridium. These pathogenic bacteria each group and proliferate under different conditions, any or all of which may be present in a meat processing facility. For example, Listeria is generally found in cool, damp environments such as coolers and meat processing areas. Staphylococcus is often found on cattle hair, in fecal material, in infected cuts and internal abscesses, and is sometimes associated with poor hygienic practices of food handlers.

Spoilage bacteria, including psychotropic bacteria such as Pseudomonedes, Lactobacillus and Coliform, affect the shelf life of meat products by causing discoloration of meat and undesired odors. These bacteria are typically found in soil, ingesta, and fecal material that are commonplace on an animal's hide.

Anti-Oxidation Effects

In addition, and complementary to the anti-microbial effects of the methods described herein, the present invention provides a means to decrease the oxidation of fats and oils, especially when subjected to heating. Moreover, the phytosterol addition to fats, oils or to food products protects any fatty acids moieties present therein by scavenging oxidative free radicals and/or peroxides that are formed during fat oxidation. This part of the dual benefit of the method described herein is most pronounced in fat and oil based food products, particularly those undergoing heating by, for example, baking, cooking and frying.

Fats and oils include, but are not limited to, vegetable oils and nut oils, (such as, for example, canola oil, sunflower oil, cottonseed oil, olive oil, coconut oil, soybean oil, cocoa butter, palm oils, peanut oil, walnut oil, flaxseed oil, linseed oil, corn oil, safflower oil), marine oils, and animal fats (such as lard, butter, tallow, grease).

The term “fat” refers to what is commonly called triglycerols or triacylglycerols (TAGs), due to the three glycerol moieties. These are a form of lipids comprised of three fatty-acid molecules attached to a glycerol backbone. The positions on the glycerol backbone are designated sn-1, sn-2 and sn-3 (stereospecific numbering). Fat also can take the form of a diacylglycerol (DAG), which contains one glycerol and two fatty acids, and a monoacylglycerol, which contains one glycerol and one fatty acid.

The fatty acids are made up of chains of carbon atoms with a terminal carboxyl group that can bond to one of glycerol's hydroxyl groups. The number of carbon atoms typically varies from between four and 26 carbon atoms arranged in a straight chain. Often, fatty acids are categorized by chain length: those called short chain have less than 10 carbon atoms, medium chain have 10 to 14 carbon atoms, and long chain have more than 14 carbons. Generally, naturally occurring fatty acids have an even number of carbons in the chain, but some exceptions occur. For example, valeric acid, a five-carbon saturated fatty acid, occasionally can be found in fermented products and milk fat.

The type of bonds between the carbon atoms also helps define fatty acids. Saturated fatty acids (SFA) contain the maximum number of hydrogen atoms; they contain no reactive double bonds between the carbons. Unsaturated fatty acids contain less than the maximum number of hydrogen atoms, because they have at least one double bond, these fatty acids can be termed monounsaturated, or MUFA, (one double bond) or polyunsaturated, or PUFA, (more than one double bond). Polyunsaturated fatty acids contain a high number of double bonds, making foods with this type of fatty acid more prone to oxidative rancidity.

These double bonds can occur as either cis or trans geometric configurations. In the more-common cis configuration, both hydrogen atoms attached to the carbons with the double bond fall on the same side of the chain, causing a bend and a more flexible molecule. The trans position has the two hydrogens positioned on opposite sides of the chain. This makes the double-bond angle of the trans fatty acid less sharp and the chain more linear, resulting in a more-rigid molecule that packs together easily. Dairy and other animal fats and a few plant fats contain some trans fatty acids, but most come from hydrogenated fats. They consist mainly on the trans isomers of oleic acid, elaidic acid (t9-18:1) and vaccenic acid (t11-18:1).

Hydrogenation removes double bonds and adds hydrogen atoms to the carbon, which transforms liquid oils into solid fats and increases resistance to oxidation. The process randomly inserts hydrogen atoms; partial hydrogenation gives a mixture of polyunsaturated and monounsaturated (both with trans isomers) and saturated fatty acids. As the degree of hydrogenation increases, monounsaturates and trans fatty acids increase, and saturates increase slightly, while the level of polyunsaturates decreases.

The chemistry of the fat and its fatty acids affects the fat's characteristics. It is accepted that the chemical and physical properties of TAGs are dictated by the chain length and extent of saturation of the associated fatty-acid moieties and the positioning of the fatty acids on the glycerol backbone.

For example, three fatty-acid factors affect melting point: the longer the chain length, the higher the melting point; the greater the degree of saturation, the higher the melting point; and a trans configuration also increases melting point. The melting point of oleic acid (9c-18:1) is 13° C., elaidic acid (9t-18:1) is 44° C., and the saturated fat stearic acid (18-0) is 70° C.

The positions occupied by the associated fatty acids on the TAG structure also contributes significantly to both properties. For example, in lard and tallow, both of which have similar fatty-acid compositions; the major fatty acids are palmitic, stearic and oleic. In lard, palmitic acid occurs almost exclusively at sn-2 and oleic at the outside positions, while in tallow the saturates are distributed at the sn-1,3 positions. The unique TAG structure of lard provides a crystal structure that makes it very desirable for bakery items, like pie crusts which require flakiness.

Human diets require only two fatty acids, called the “essential” fatty acids: linoleic acid and alpha-linolenic acid. The body cannot synthesize these, and requires them to produce eicosanoids, compounds that help regulate blood clotting, blood pressure, heart rate, immune response and many other biological processes.

Linoleic acid (18:2n-6) is called “omega-6,” or “n-6,” because its first double bond occurs at the sixth carbon from the omega, or methyl (—CH3), end of the fatty acid. Vegetable and nut oils, such as sunflower, safflower, corn, soy and peanut, contain significant amounts, so most Americans have adequate levels of linoleic or omega-6 fatty acids in their diets. Alpha-linolenic acid (18:3n-3) is an “omega-3,” or “n-3,” fatty acid because its first double bond comes at the third carbon from the omega end. It can be found, for example, in flaxseed oil (51% linolenic acid), canola oil (9%), soy oil (7%) and walnuts (7%).

Linoleic acid can be oxidized by the body to produce energy, or converted by enzymes to longer-chain PUFAs such as gamma-linolenic acid (GLA), dihomo-gamma-linolenic acid (DGLA) and arachidonic acid (M). The body uses the same enzymes to convert alpha-linolenic acid to eicosapentaenoic acid (EPA) and docosahexaenoic acid (DHA), though this is a somewhat inefficient process. Therefore, some experts suggest a direct intake of these two long-chain omega-3s.

Soybean, canola and flaxseed oils contain relatively high levels of linolenic acid. The long-chain (lc) omega-3 PUFAs EPA (20:5n-3) and DHA (22:6n-3) are found in marine oils, particularly cold-water fish. Research is finding that including marine-derived lcPUFAs in the diet may reduce the incidence of coronary heart disease and stroke, and may have a beneficial effect on other disorders (including dyslexia, arteriosclerosis and asthma). Omega-3 PUFA oils also aid brain and retina development and function.

Fats and oils are used extensively in the food industry, in home meal preparation and in restaurants. Almost all oils can be used for frying, although highly unsaturated oils have been considered less desirable due to their inferior stability and the fact that they degrade faster than oils with no or fewer double bonds. Any means by which the shelf life and cooking stability of oils and fats and food products containing them is of vast importance to the food industry. Such means is described herein by way of the present invention.

The two main degradation processes for oils and fats are oxidation and hydrolysis. In hydrolysis, the fatty acids are hydrolyzed off the triacylglycerides at high temperatures in the presence of water (i.e., frying conditions), yielding free fatty acids, monoglycerides, diglycerides, and glycerol. These breakdown products will speed up the degradation of the remaining triacylglycerides as they allow greater emulsification of water from the food into the oil or fat. In oil or fat oxidation, the carbon atoms next to the double bonds are oxidized, which results in a break of the hydrocarbon chain and the formation of volatile compounds, including aldehydes, ketones, alcohols, short chain fatty acids, and other compounds that may introduce an off-odor to the oil or fat. A third type of degradation process, which is the formation of polymers, will darken the color of oil and can ultimately lead to an increase in viscosity and solidification therein. However, this degradation process, while sped up by the frying conditions, is of little importance because the other two degradation processes will render the oil inedible long before polymerization will affect the oil.

The process of the present invention is important and will be of great use to many sectors of the food industry: suppliers of oils, fats and ingredients, food service (hotel, restaurants and institutions) operators, and the food industries (in particular snack, fully fried and par-fried foods). The amount of food fried and oil used at both industrial and commercial levels is vast. The US produces over 2.5 million metric tonnes (MMT) (5×10⁹ lb) of snack food per year, the majority of which is fried (SFA 1997 State of the Snack Food Industry Report, Snack Food Association Alexandria Va.). There are more than 500,000 institutional and commercial restaurants in me US which utilize approximately 1 MMT (2×1 ⁹ lbs) of frying fats and oils annually (O'Brien R. 1993 Foodservice use of fats and oils INFORM 4(8):913-921).

Fats and oils are responsible for carrying, enhancing and releasing the flavour of other ingredients as well as for interacting with other ingredients to develop the texture and mouthfeel characteristics of fried foods. As described above, they provide dietary essential fatty acids, fat soluble vitamins (A, D, E and K) and energy. Accordingly, fats and oils play important functional and sensory role in food products and the present invention, by providing a means to maintain the integrity thereof, assists in the purveyance of these benefits. A particular value of the present invention is in the protection of the essential fatty acids from oxidation and deterioration, not only at room temperature storage, but more critically, during various heating processes as it has been found that thermal oxidative changes in oils during heating (especially deep-frying) results in marked losses of these fatty acids (Irwandi et al 2000 JAOCS 77:527-533).

It is be be understood that within the scope of the present invention phytosterois and/or phytostanols may be added to food products and this includes the direct addition of phytosterols and/or phytostanols to oils, in particular liquid edible oils and to various fats, in particular those which are hard at room temperature.

While the amount of phytosterol and/or phytostanol to be added to the food product will depend on a number of factors, including the type of food product, it is generally preferred that the phytosterol and/or phytostanol is added in an amount totalling from between 0.05% to 10% by weight of the food product.

### EXAMPLES

The present invention is described by the following non-limiting examples:

### Example 1

### Preparation of Yoghurt Comprising Microparticulates of Phytosterols and/or Phytostanols

A composition of plant sterols/stanols having campesterol (14.5%), campestanol (2.4%), beta-sitosterol (50.9%) and sitostanol (18.9%) (hereinafter referred to as “Reducol™”) was mixed with non-fat milk powder in the ratio of 1:7 to 1:8. About 6 L of milk mix was prepared from whole milk, skimmed milk and the Reducol containing milk powder. Milk was standarized to 0.76-1% fat, 12-13% solids and 0.5-1% Reducol using the Pearson's Square method (Hyde, K A and Rothwell, J. 1973, in Ice Cream, Churchill Livingstone Ltd., London U.K.). The milk mix was permitted to remain at room temperature for 30 minutes to re-hydrate the milk powder and then it was homogenized using a high-speed microfluidizer commercially available from Microfluidics Corporation, Newton, Mass. (USA). Next, milk was then pasteurized at 69° C. (156° F.) for 30 minutes (batch/vat), cooled to 44° C. and held at this temperature for up to 30 minutes.

About 3% by weight of active yoghurt culture containing Lactobacillus bulgaricus and Streptococcus thermophilus in the ratio of 1:1 were carefully introduced into the warm milk mix. After gentle mixing, the inoculated milk was distributed into 125 ml containers filling to near top. The containers were thermally sealed with aluminum leads and placed in an incubator (44° C.) equipped with a good uniform air circulator and temperature controller. Filled containers were permitted to remain at 44° C. for 3-5 hours, until a firm, smooth gel was formed. During incubation, pH was monitored periodically. When pH reached about 4.5, the yoghurt was withdrawn from the incubators chilled quickly and stored at 4° C.

### Example 2

### Preparation of a Vegetable Spread/Emulsion Comprising Microparticulates of Phytosterols and/or Phytostanols

A mixture of soybean oil and palm oil with Reducol in the concentration range of 50-80% can be used to develop an emulsion. A small portion of hydrogenated vegetable oil (2-5%) can be added in order to obtain the desired texture. Two types of emulsions are possible: oil-in-water, which is preferable for the development of the low-fat spread and water-in-oil, which is preferable for some other applications. Appropriate emulsifiers or stabilizing agents such as lecithin, polysorbates and lactylates are used to stabilize the emulsion. Thickening agents such as gums (xanthan gum, locust bean gum, guar gum etc.), gelatin, pectins, and agar may also be added. To colour the spread, beta-carotene, caramel colour and FD&C yellow dye may be used. Furthermore, enriching the oil phase with vitamins A and D as well as with essential polyunsaturated fatty acids is possible.

A spread composition is as follows:

| | |
|---|---|
| Vegetable oil (liquid) | 50-80% |
| Vegetable, saturated fat | 0-5% |
| Reducol | 9-15% |
| Emulsifier | 0.2-1% |
| Thickening agent | 0-10% |
| Butter Flavour, colourant, salt | various, as required |
| Water | to 100% |

All of the ingredients are blended in a stainless steel vessel equipped with a high sheer batch mixer such as the T50 Ultra Turrex. After blending is completed, and the mix has the consistency of heavy cream, the blend is tempered to a consistency of margarine by letting it sit for a couple of hours. To stabilize the emulsion and concomittantly to reduce the particle size of the Reducol component, the spread is homogenized in a microfluidizer.

### Example 3

### Preparation of a Cereal Bar Comprising Microparticulates of Phytosterols and/or Phytostanols

It has been found by the applicants herein that Reducol can be dispersed in fat up to 27% (and possibly more). For this reason, cereal bars having fat-based binders have been investigated. In this example, Reducol is dispersed in fat to form a continuous emulsion. This fat component is then combined with carbohydrates and optionally with other ingredients to form a binder suitable to maintain the strength and elastic properties of the cereal bar.

a) Binder

Generally, the fat-binder composition in cereal bars ranges from about 20-85% fat, and 20-60% carbohydrates by weight. The strength of the cereal bar is improved with the addition of up to 1% monoglycerides and diglycerides, however, since they have relatively high melting points compared to triglycerides, they should be used only in small proportions. Optionally, various emulsifiers, film formers (e.g. sodium caseinate or alternatively egg albumin, soy protein), colour and flavour components, vitamins and minerals may be added.

A Binder Composition is as Follows:

| | |
|---|---|
| Reducol containing fat | 40% |
| Sucrose | 22% |
| Water | 28% |
| Sodium Caseinate | 5% |
| Lecithin | 2% |
| Glycerin | 3% |

These ingredients are mixed at room temperature or added to boiled sucrose in water. Mixing is carried out vigorously using a suitable mixer (e.g. Hobart mixer) with the aim being to disperse the fat globules (discontinous pahse) in the film former/sucrose syrup (continuous phase). During this mixing process, fat is encapsulated. To determine whether this process is complete, place one drop of the dispersion in water at 60° C. If fat is released, mixing is not complete and should be continued.

a) Cereal Bar

Any combination of oats, crisp cereals (corn and wheat flakes, Rice Krispies™), nuts, raisins and fruits, in various proportions comprise the “edible particles”. All edible particles should be ready-to-eat. Cereals can be extruded, toasted or roasted in unsaturated oil such as soy or canola oil.

Composition of cereal bar

| | |
|---|---|
| Binder (with Reducol) | 40% |
| Edible particles | 55% |
| Water | 5% |
| Edible Particles: | |
| Rolled oats | 40% |
| Crisped rice | 15% |
| Puffed barley | 15% |
| Dried Apple Dices | 15% |
| Shredded Coconut | 7.5% |
| Raisins | 7.5% |

All of these ingredients are mixed thoroughly in a Hobart Mixer equipped with a kneeling device and a rotating bowl. The binder may be heated up to 40-50° C. and placed first in the bowl followed by the other ingredients. Thorough mixing without causing size reduction of the edible particles should be used the criterion to set up time of mixing. After mixing is complete, mixed material is placed in a forming mold (10×50×0.6 cm) and pressed with a roller. After removal from the mold, it is cut into 4×10 cm ready-to-eat cereal bars. After forming and cutting, the bars may be single or double enrobed using dairy-based or chocolate cover. Bars should be stabilized at 10° C. for 15-20 minutes before packing.

### Example 4

### Preparation of Chocolate Confection Comprising Microparticulates of Phytosterols and/or Phytostanols

Chocolate is a dispersion of sugar and cocoa particles in a continuous phase of cocoa butter. The solid particles should generally be less than 20 um in diameter for the chocolate to have a smooth texture.

To make Reducol-containing chocolate, Reducol can either be mixed with cocoa particles (having undergone some impact procedure as described herein in order to reduce particle size) and used as such or alternatively Reducol can be incorporated into cocoa butter using microfluidizing technology. Plain, white or milk chocolate can be made.

In the first approach, microparticulate Reducol is mixed with cocoa powder, sugar, milk powder, emulsifier (soy lecithin), a film former and flavour agents (e.g. natural or artificial vanillin flavour). The dry mixing is conducted using a batch mixer such as T50 Ultra Turrex. Susequently, cocoa butter and milk are added and the formulation mixed thoroughly. After mixing, chocolate mass is tempered and used for molding.

In the second approach, Reducol is incorporated directly into the cocoa butter. Cocoa butter is mixed with non-milled Reducol powder and then passed through a microfluidizer (M-110Y Microfluidics International Co., Newton, Mass. USA) until the particle size is in the range of 10-20 microns using the procedure described in Example 2.

Once Reducol-containing Butter is produced it is then used to prepare chocolate.

### Example 5

### Preparation of Soy Drink Comprising Microparticulates of Phytosterols and/or Phytostanols

Soy drink is made of whole soybeans with filtered or purified water. It may contain added calcium, vitamin D, vitamin B-12 and natural or artificial flavour. In this example, soy drinks are enriched with Reducol.

Reducol is mixed with the soy drink of choice in the concentration ranges of 0.5-6% using a batch mixer (T50 Ultra Turrex). Samples are then submitted to the microfluidizer and emulsified.

### Example 6

### Dissolution in Oils—Phytosterols in Soybean Oil

A number of compositions were prepared comprising phytosterols dissolved in oil, without the necessity of emulsifiers.
A) “Reducol”, as noted above, was selected for dissolution in soybean oil. 0.5 grams of this composition (5% w/w) was heated to a molten condition under the heat of an oil bath at approximately 140° C. The molten phytosterol blend was added to 9.5 grams soybean oil (95% w/w) at approximately 140° C. The final composition was mixed for about 2 minutes while the temperature was reduced to 100-110° C.
B) 0.6 grams of Reducol (6% w/w) was heated to a molten condition under the heat of an oil bath at approximately 140° C. The molten phytosterol blend was added to 9.4 grams soybean oil (94% w/w) at approximately 140° C. The final composition was mixed for about 2 minutes while the temperature was reduced to 100-110° C.
C) 0.7 grams of Reducol (7% w/w) was heated to a molten condition under the heat of an oil bath at approximately 140° C. The molten phytosterol blend was added to 9.3 grams soybean oil (93% w/w) at approximately 140° C. The final composition was mixed for about 2 minutes while the temperature was reduced to 100-110° C.
D) 0.8 grams of Reducol (8% wow) was heated to a molten condition under the heat of an oil bath at approximately 140° C. The molten phytosterol blend was added to 9.2 grams soybean oil (92% w/w) at approximately 140° C. The final composition was mixed for about 2 minutes while the temperature was reduced to 100-110° C.
E) 0.9 grams of Reducol (9% w/w) was heated to a molten condition under the heat of an oil bath at approximately 140 CL. The molten phytosterol blend was added to 9.1 grams soybean oil (91% w/w) at approximately 140° C. The final composition was mixed for about 2 minutes while the temperature was reduced to 100-110° C.
F) 1.0 grams of Reducol (10% w/w) was heated to a molten condition under the heat of an oil bath at approximately 140° C. The molten phytosterol blend was added to 9.0 grams soybean oil (90% w/w) al approximately 140° C. The final composition was mixed for about 2 minutes while the temperature was reduced to 100-110° C.

The 5% w/w phytosterol composition so formed yielded a clear solution with no discernible precipitation or crystals and was the most preferred composition without emulsifier. Control sample compositions were prepared having comparable % ratios of the components, but made simply by adding the oil and phytosterols together with heat applied for approximately 3 minutes. As compared to the control samples, each of the compositions prepared by the method of the present invention was more clear indicating greater dissolution of the phytosterols.

### Example 7

### Dissolution in Oils—Phytosterols and Emulsifiers in Soybean Oil

Three types of emulsifiers were tested: EMULTOP™ (a lyso-PC enriched lecithin); EPIKURON 200™ (containing over 98% phospholipids) and Phosphoderm™ (approximately 80% phospholipids in alcohol). Each of these three were tested at amounts ranging from 0.01% whir to 1% w/w. Phytosterol amounts ranged from 5-10% w/w. The protocol described below for Epikuron at each set amount and phytosterols at 5% wow is applicable to all compositons, substituting, of course, the different percentages of the three components. In addition, a series of tables below sets out the exact proportions of emulsifier, phytosterols and oil used in preparing each of the compositions.
A) A mixture of phytosterols, Reducol as noted above was selected for dissolution in soybean oil. 0.5 grams of Reducol (5% w/w) was heated to a molten condition under the heat of an oil bath at approximately 140° C. 0.1 grams of Epikurion 200 (1% w/w), an emulsifier with over 98% phospholipids was added and stirred into the melted phytosterols. After being well mixed, the phytosterol/phospholipids were added to 9.4 grams soybean oil (94% w/w) at approximately 140° C. The final composition was mixed for about 2 minutes while the temperature was reduced to 100-110° C.
B) 0.5 grams of Reducol (5% w/w) was heated to a molten condition under the heat of an oil bath at approximately 140° C. 0.05 grams of Epikurion 200 (0.5%) was added and stirred into the melted phytosterols. After being well mixed, the phytosterol/phospholipids were added to 9.45 grams soybean oil (94.5%) at approximately 140° C. The final composition was mixed for about 2 minutes while the temperature was reduced to 100-110° C.
C) 0.5 grams of Reducol (5% w/w) was heated to a molten condition under the heat of an oil bath at approximately 140° C. 0.03 grams of Epikurion 200 (0.3%) was added and stirred into the melted phytosterols. After being well mixed, the phytosterol/phospholipids were added to 9.47 grams soybean oil (94.7%) at approximately 140°(C. The final composition was mixed for about 2 minutes while the temperature was reduced to 100-100° C.
D) 0.5 grams of Reducol (5% w/w) was heated to a molten condition under the heat of an oil bath at approximately 140° C. 0.01 grams of Epikurion 200 (0.1%) was added and stirred into the melted phytosterols. After being well mixed, the phytosterol/phospholipids were added to 9.49 grams soybean oil (94.9%) at approximately 140° C. The final composition was mixed for about 2 minutes while the temperature was reduced to 100-110° C.
E) 0.5 grams of Reducol (5% w/w) was heated to a molten condition under the heat of an oil bath at approximately 140° C. 0.001 grams of Epikurion 200 (0.01%) was added and stirred into the melted phytosterols. After being well mixed, the phytosterol/phospholipids were added to 9.499 grams soybean oil (94.99%) at approximately 140° C. The final composition was mixed for about 2 minutes while the temperature was reduced to 100-110° C.
F) 0.5 grams of Reducol (5% w/w) was heated to a molten condition under the heat of an oil bath at approximately 140° C. The molten phytosterol blend was added to 9.5 grams soybean oil (95%) at approximately 140° C. The final composition was mixed for about 2 minutes while the temperature was reduced to 100-110° C.

The best results i.e. clearest compositions with no discernible precipitation or crystals were obtained with 7% w/w phytosterol or less and 0.30% w/w lecithin (EMULTOP) as emulisifer and with 8% w/w or less phytosterol and 0.30% w/w phospholipids (PHOSPHODERM) in alcohol as emulsifier.

It should be noted that, while the phytosterols may be substantially completely dissolved in many of these compositions, the colour of the composition may be intensified by the addition of some types of emulsifiers. For example, lecithin in the presence of carbohydrates is subject to cameralization at high temperatures resulting in an oil of dark brown colour. Similarly, the colour of the oil may be intensified by the addition of Phosphoderm.

### Example 8

### Yogurt

A phytosterol blend which consists of campesterol, campestanol, β-sitosterol and sitostanol was dissolved in oil and then mixed with nonfat milk powder in the ratio of 1:7 to 1:8. About 6 L of milk mix was prepared from whole milk, skimmed milk and Reducol, as noted above, containing milk powder. Milk was standardized to 0.755-1% fat, 12-13% solids and 0.5-1% of the phytosterol blend using the Pearsons Square method (Hyde, K. A. and Rothwell, J., 1973, in Ice Cream, Churchill Livingstone Ltd., London, U.K.). Milk mix was permitted to remain at room temperature for 30 minutes to rehydrate powder milk and than it was homogenized using a high sheer batch mixer (Ultra-Turrax T50 equipped with the dispersing element S50N, IKA Works Inc., Wilmington, N.C., USA). Other devices such as a single-stage homogeniser, a two stage homogeniser or a high-pressure microfluidizer may alternatively be used for homogenization of the milk mix. Next, milk mix was pasteurized at 69° C. (116° F.) for 30 minutes (batch/vat), cooled to 44° C. and hold at this temperature for up to 15 minutes.

About 3% by weight of active yogurt culture containing Lactobacillus bulgaricus and Streptococcus thermophilus in the ratio 1:1 were carefully introduced into warm milk mix. After gentle mixing, the inoculated milk was distributed into 125 g-containers filling to near top. The containers were thermally sealed with aluminum leads and placed in incubator (44° C.) equipped with good uniform air circulator and temperature controller. Filled containers were permitted to remain at 44° C. for 3-5 hours, until a firm, smooth gel was formed. During incubation, pH was monitored periodically. When pH reached about 4-5, yogurt was withdrawn from the incubator, chilled quickly and stored at 4° C.

### Example: 9

### Bread

Breads containing 0.6% and 1.2% of a phytosterol blend comprising campesterol, campestanol, β-sitosterol and sitostanol (referred to herein as “Reducol”) dissolved in oil (Crisco) were prepared using bread maker (Black & Decker, Model # B2005). The phytosterol composition (Crisco plus phytosterols) was mixed with the other ingredients in proportions indicated below.

| Ingredients | 0.6% Reducol (g) | 1.2% Reducol (g) |
|---|---|---|
| Milk | 334.00 | 334.00 |
| Salt | 7.50 | 7.50 |
| Sugar | 7.10 | 7.10 |
| Crisco | 12.00 | 12.00 |
| Flour | 535.00 | 535.00 |
| Reducol | 5.42 | 10.84 |
| Yeast | 2.80 | 2.80 |

Ingredients were combined in the baking pan of broad maker. Preparation of dough and baking was conducting according the manufacturing instructions.

### Example: 10

### Cereal Bar

Cereal bars of total weight 20 g, and 40 g that contained 3%, and 1.5% of Reducol, respectively, were prepared. Reducol consisted of campesterol, campestanol, β-sitosterol and sitostanol was dissolved in partially hydrogenated vegetable oil. The oil/Reducol blend was cooled to 30° C. and emulsified using a high sheer batch mixer (Ultra-Turrax 150 equipped with the dispersing element S50N, IKA Works Inc. Wilmington, N.C., USA). Subsequently, two oil blends (9.4% and 18.8% of Reducol) were further emulsified using a high-pressure microfluidizer at 20,000 PSI.

Cereal bars were produced by combining binder (40%), water (5%) and edible particles (55%). Below two typical examples of binder used for making a cereal bar.

Sucrose Containing Binder

| | |
|---|---|
| Reducol (9.4% or 18.8%) containing oil | 40% |
| Sucrose | 22% |
| Water | 28% |
| Sodium Caseinate | 5% |
| Lecithin | 2% |
| Glycerin | 3% |

Glucose Containing Binder

| | |
|---|---|
| Reducol (9.4% or 18.8%) containing oil | 40% |
| Glucose syrup | 50% |
| Sodium Caseinate | 5% |
| Lecithin | 2% |
| Glycerin | 3% |

Sucrose in water/glucose syrup was heated to 100° C. while Reducol containing fat was liquefied at 40-80° C. Hot sugar solution was placed in the bowl (Hobart mixer, Model N50) and fat was added followed by adding all remaining binder ingredients. All ingredients were thoroughly and vigorously mixed. After cooling down to 40° C., edible particles are added while thorough, non-vigorous mixing was carried out. Following edible particles were typically incorporated into the cereal bars.

Edible Particles

| | |
|---|---|
| Rolled oats | 20-40% |
| Crisped rice | 10-20% |
| Puffed barley | 10-20% |
| Dried apple dices | 10-20% |
| Shredded coconut | 5-10% |
| Raisins | 5-10% |
| Various nuts | 5-10% |

After mixing was completed, mixed material was placed in the forming mold and pressed with a roller. After removal from the mold, it was cut into ready to eat various sizes cereal bars.

### Example: 11

### Spread

Light margarine (60% fat) containing 6% of Reducol was produced in batches of 5-10 kg. Reducol comprised campesterol, campestanol, β-sitosterol and sitostanol was dissolved in oils. Clear fat solution was placed in the feeding tank (20 L), cooled to 40-45° C. and stirred using (Ultra-Turrax T50 equipped with the dispersing element S50N, IKA Works Inc, Wilmington, N.C., USA). Next, the water fraction (40%) was added and temperature was adjusted to 60° C. The blend was submitted into a votator and processed at 8-10° C. The composition of margarine is described below.

| Ingredient | Wt % |
|---|---|
| Water Phase | |
| Water | 39.0 |
| Salt | 1.0 |
| Potassium sorbate | 0.001 |
| Oil Phase | |
| Soybean oil | 38.025 |
| Palm kernel oil | 15.0 |
| Reducol | 6.0 |
| Mono/diglycerides | 0.6 |
| Lecithin | 0.15 |
| Flavor | 0.075 |
| Beta-carotene | 0.15 |

### Example 12

### Chocolate

Milk chocolate containing 6% of Reducol was produced in batches of 20-50 kg. Reducol, comprising campesterol, campestanol, β-sitosterol and sitostanol was dissolved in soybean oil. The blend (20% Reducol) was subsequently emulsified using a high-pressure microfluidizer at 20,000 PSI. Chocolate was composed of an outer shell (42 wt %, no Reducol) and a center (69%, Reducol). Chocolate outer shell was made by mixing sugar (45%), whole milk powder (20%), cocoa butter (23%), cocoa mass (12%), soy lecithin (0.3%) and pure vanilla (0.1%) in a heating tank. All ingredients were melted, tempered and deposited into molds. Center was prepare my mixing sugar, cocoa butter, whole milk powder, cocoa mass, soy lecithin and pure vanilla in the proportions as for outer shell. The mix was melted and tempered. Consequently, Reducol/soybean oil blend was mixed with chocolate in the 1:1 ratio and deposited into molds previously filled with chocolate without Reducol. Chocolate pieces were than cooled, wrapped and packed into the boxes. Using the molding system, 10-12 g chocolate pieces were produced.

### Example 13

### Microbial Reduction in Milk

Milk drinks were formulated (2% milk fat and 8.9% milk solids-not-fat) applying the following treatment variables: addition of phytosterol/phytostanol mixture (beta-sitosterol, beta-sitostanol, campesterol and campestanol, hereinafter referred to only as “phytosterol(s)”) (0, 0.26%, 0.72%), application of microfluidization pressure (0, 5,000 PSI), addition of stabilizer (0, 0.016%), and storage at 4±1° C. (0, 9 days, 18 days).

Twenty percent of the phytosterol/phytostanols dispersed in skimmed milk was microfluidized at 20,000 PSI (Model M-110Y Microfluidizer Processor, Microfluidics International Corporation, Massachusetts), and this preparation was used in the formulation of the phytosterol/phytostanol-treated milk drinks.

Milk drink was composed of 60.3% milk (3.26% milkfat, 8.71% MSNF), 36.702% skimmed milk, 0.257% skimmed milk powder, 0.016% of the stabilizer: kappa-carrageenan (Food Specialties, Mississauga, Ontario), 1.465% water, and 1.26% of 20% phytosterols pre-dispersed in skimmed milk.

Skimmed milk was heated to 40° C., with continuous gentle agitation. Phytosterols (1 part of phytosterols to 4 parts of skimmed milk) was gradually added, while continually increasing the temperature to 60-65° C. With the aid of a hand blender (Rival Ultra Blend IB953-CN, Sedalia, Mo.), the mixture was carefully dispersed for 1-2 minutes until the phytosterol particles were smoothly incorporated into milk. Careful attention was taken to avoid excessive foaming. Next, suspension was heated to 65-70° C. for 2 minutes allowing the foam to subside, microfluidized at 20,000 PSI, and then heated again to 75° C. with gentle agitation.

Five liters of milk drink for each of the twelve formulations was prepared. Milk, skimmed milk and water were mixed and warmed to 35° C. The pre-blended skimmed milk powder and kappa-carrageenan was added, and then heated to 60-65° C., with continuous gentle agitation. A measured amount of milk containing 20% of phytosterols was poured in, heated to 65-70° C., microfluidized at 5000 PSI, and pasteurized at 65-70° C. for 30 minutes. The milk drink was immediately cooled to 4° C., with continuous gentle agitation, packaged in 100-mL, 500-mL and 1-L high-density polyethylene containers, and then stored at 4±1° C.

Samples from each milk drink formulation were collected at 9- and 18-day-old milk drinks and analyzed for total bacteria count and coliform count.

As expected, coliform was not observed in all milk drinks throughout the storage period of 18 days at 4±1° C. Total plate count (TPC), however, appeared to increase with storage and was observed to be lower in milk drinks with phytosterols. It was observed that the milk drink without phytosterols contained higher bacterial numbers compared to the phytosterols-treated drinks. Milk drinks with 0.24% and 0.72% phytosterols had 32 CFU/g and 30 CFU/g TPC, respectively, at 9 days of storage; and 4×10³ CFU/g and 2.8×10³ CFU/g, respectively, at 18 days; while milk without phytosterols contained about 10³-10⁴ at 9 days and 10⁶ at 18 days of storage. Furthermore, the bacteriostatic property of phytosterols was the dose dependant and may be associated with the hydrophobic structure of phytosterols.

### Example 14

### Anti-Oxidant Effect

Testing was undertaken to determine the effectiveness of phytosterols in protecting against essential fatty acid losses due to thermal oxidation of frying oils.

Various oils (paraffin oil, rapeseed oil, soybean oil, sunflower oil, high oleic sunflower hydrogenated oils and rapeseed/palm oil blends) were enriched with phytosterol mixtures. These mixtures comprised 68.5% beta-sitosterol, 18.5% sitostanol, 8% campesterol and 1.5% campestanol. Oils then heated to between 100-200° C. for from 15 minutes to 96 hours of deep frying.

Results:

Medium Chain (60%) Triglyceride Oil [Linoleic Acid (8.3%) Linolenic
Acid (6.9%)]

| Group I | Group II | Group III | Group IV |
|---|---|---|---|
| Control | 3.4% | 0.2% Rosemary | 0.02% a- |
| | Phytosterols | Extract | tocopherol |

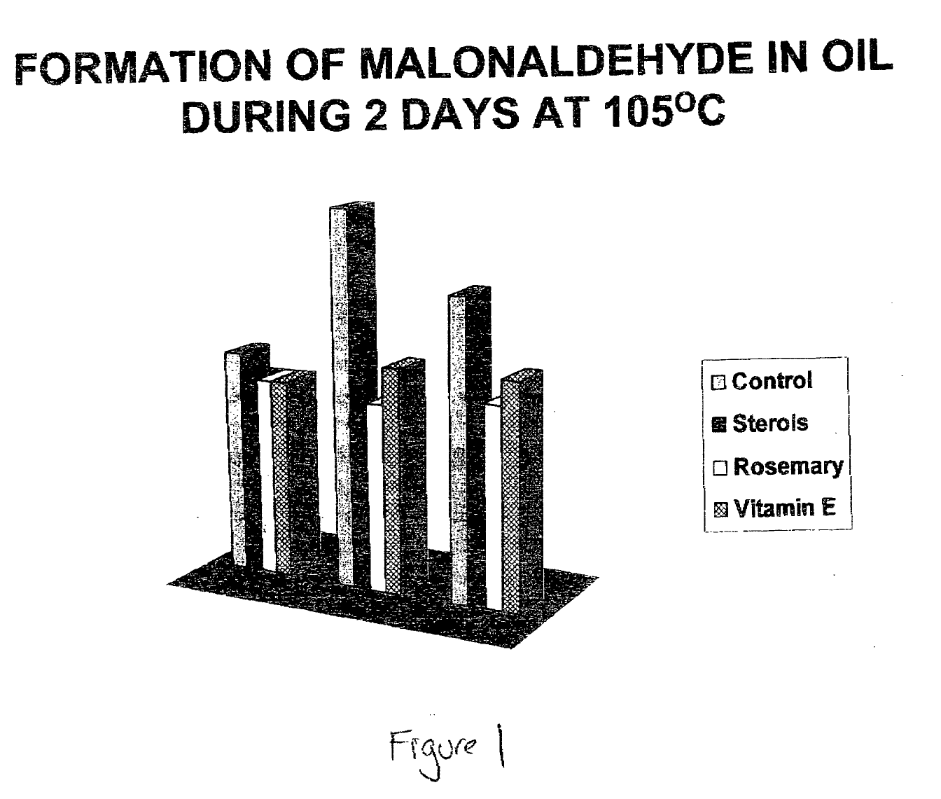

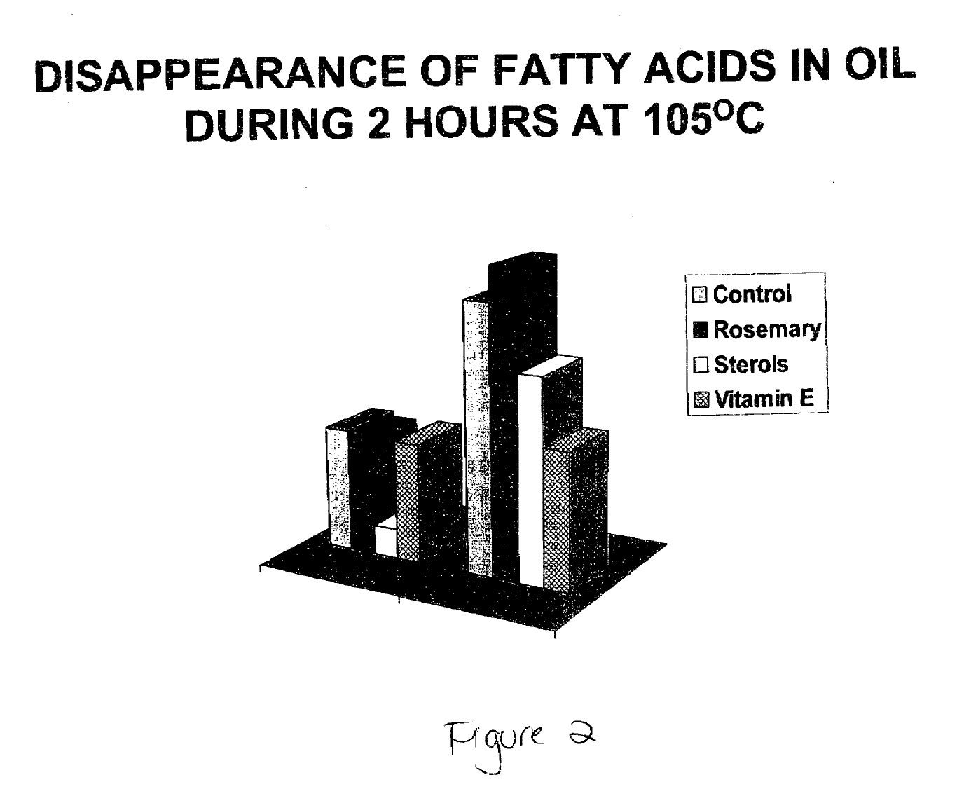

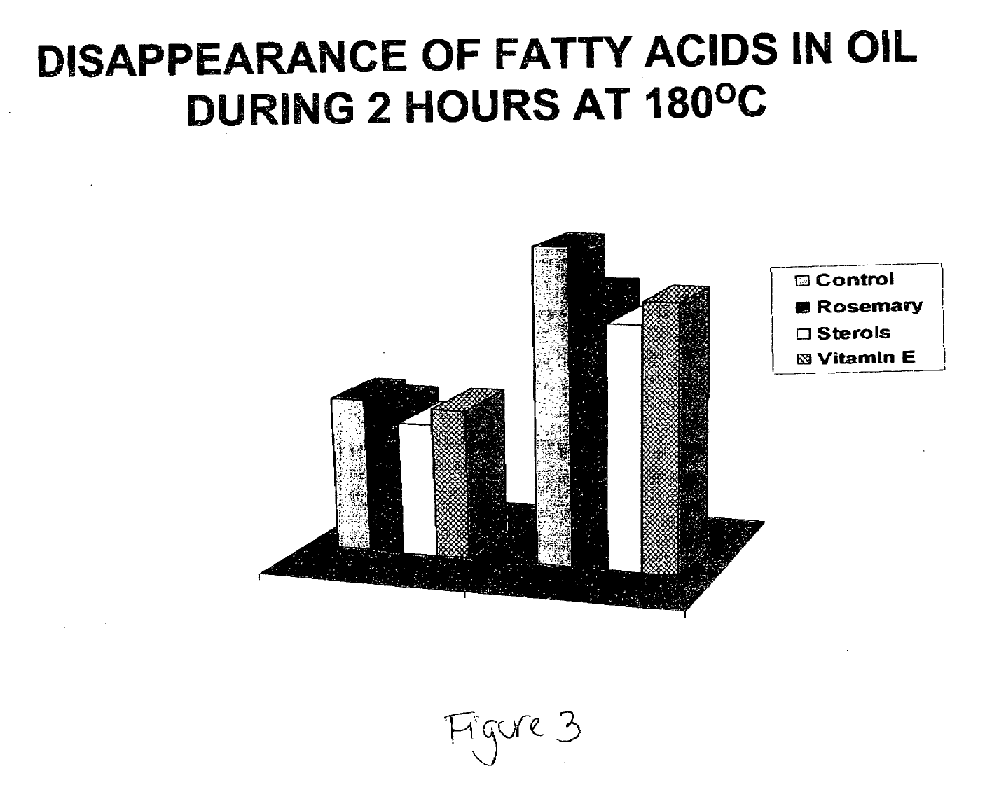

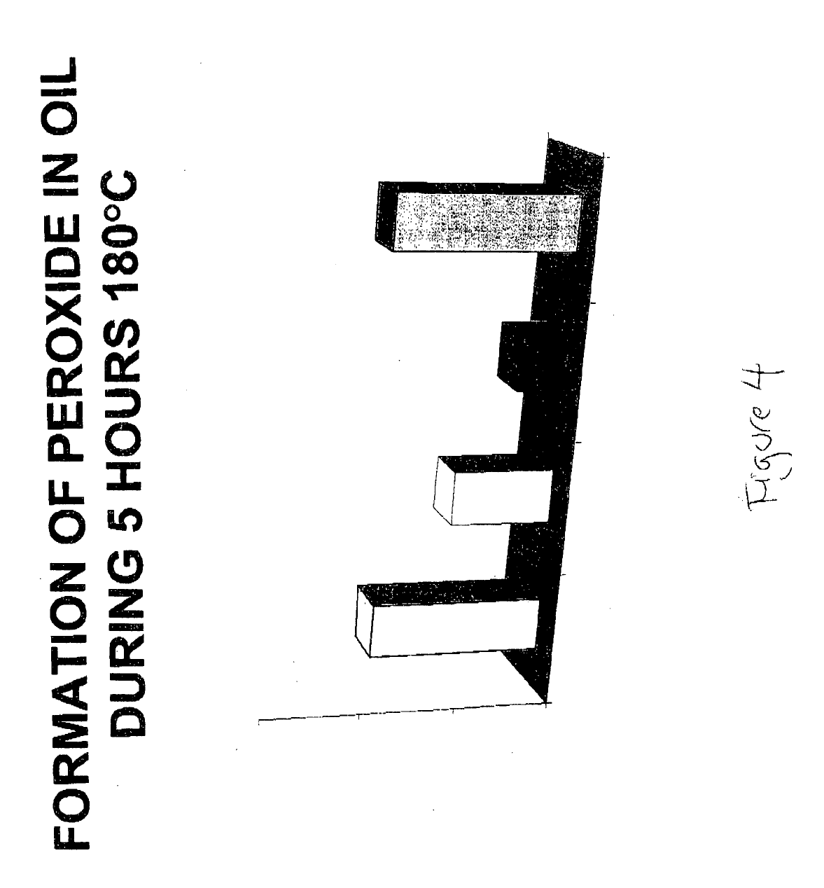

FIG. 1 shows the formation of malonaldehyde, an indicator of oxidative state (the greater its formation, the greater degree of oxidation occurring). It is clear from FIG. 1 that for the oil comprising the phytosterol/stanol mix, malonaldehyde formation is significantly decreased as compared to the control. Likewise, as shown in FIG. 4, peroxide formation is significantly reduced for the oil comprising the phytosterol/stanol mix. FIGS. 2 and 3 show a clearly reduced degree of fatty acid loss, at two different temperatures, in the oil supplemented with the phytosterol/stanol mix, as compared to the control.

These results illustrate the significant advantage of the present invention.

1. A method of preserving a food product from both deterioration due to microbial growth and oxidation of any constituent fats or oils which nay be present within said food product, which comprises adding to the food product one or more phytosterols, phytostanols, or mixtures thereof.

2. The method of claim 1 wherein the phytosterol is selected from the group consisting of sitosterol, campesterol, stigmasterol, brassicasterol (including dihydrobrassicasterol), desmosterol, chalinosterol, poriferasterol, clionasterol, ergosterol, coprosterol, codisterol, isofucosterol, fucosterol, clerosterol, nervisterol, lathosterol, stellasterol, spinasterol, chondrillasterol, peposterol, avenasterol, isoavenasterol, fecosterol, pollinastasterol and all natural or synthesized forms and derivatives thereof, including isomers.

3. The method of claim 1 wherein the phytostanol is selected from the group consisting of all saturated or hydrogenated phytosterols and all natural or synthesized forms and derivatives thereof, including isomers.

4. The method of claim 1 wherein the phytosterols and/or phytostanols are in form selected from the group consisting of: aliphatic acid esters, aromatic acid esters, phenolic acid esters, cinnamate esters, ferulate esters, phytosterol/phytostanol glycosides, and phytosterol/phytostanol acylglycosides.

5. The method of claim 1 wherein the phytosterols added are in the form of a composition comprising one or more free phytosterols and phytostanols (“free sterols”) and one or more esterified phytosterols and phytostanols (“esterified sterols”).

6. The method of claim 5 wherein the composition comprises at least 10% (by weight) free sterols.

7. The method of claim 5 wherein the composition comprises between 10-90% by weight free sterols.

8. The method of claim 5 wherein the composition comprises free sterols and esterified sterols in a ratio of about 1:1.

9. The method of claim 1 wherein the phytosterol and/or phytostanol is added in an amount totalling from between 0.05% to 100% by weight of the food product.

10. The method of claim 1 wherein the food product is fat-based.

11. The method of claim 1 wherein the food product is a liquid edible oil.

12. The method of claim 1 wherein the food product includes beverages.

13. The method of claim 1 wherein the food product is a particulate food material.

14. The method of claim 1 wherein the food product is selected from the group consisting of dairy products, margarine, peanut and other butters, shortening, meats, poultry, fish, seafood, sauces, fruits, vegetables, grains, grain-derived products, baked goods, fried snack products, confections and chocolate.

15. The method of claim 1 wherein the food product is ground meat.

16. The method of claim 1 wherein the food product is a nutraceutical.

17. The method of claim 1 wherein the phytosterols and/or phytostanols are effective against bacterial, viral, yeast and fungal growth.

18. A food product comprising an anti-microbiologically effective amount of one or more phytosterols, phytostanols, or mixtures thereof.

19. The food product of claim 18 wherein the phytosterol is selected from the group consisting of sitosterol, campesterol, stigmasterol, brassicasterol (including dihydrobrassicasterol), desmosterol, chalinosterol, poriferasterol, clionasterol, ergosterol, coprosterol, codisterol, isofucosterol, fucosterol, clerosterol, nervisterol, lathosterol, stellasterol, spinasterol, chondrillasterol, peposterol, avenasterol, isoavenasterol, fecosterol, pollinastasterol and all natural or synthesized forms and derivatives thereof, including isomers.

20. The food product of claim 18 wherein the phytostanol is selected from the group consisting of all saturated or hydrogenated phytosterols and all natural or synthesized forms and derivatives thereof, including isomers.

21. The food product of claim 18 wherein the phytosterols and/or phytostanols are in form selected from the group consisting of: aliphatic acid esters, aromatic add esters, phenolic acid esters, cinnamate esters, ferulate esters, phytosterol/phytostanol glycosides, and phytosterol/phytostanol acylglycosides.

22. The food product of claim 18 wherein the phytosterol and/or phytostanol is present in an amount totalling from between 0.05% to 10% by weight of the food product.

23. The food product of claim 18 which is fat-based.

24. The food product of claim 18 which is a liquid edible oil.

25. The food product of claim 18 selected from the group consisting of dairy products, margarine, peanut and other butters, shortening, meats, poultry, seafood, sauces, fruits, vegetables, grains, grain-derived products, baked goods, fried snack products, confections and chocolate.

26. The food product of claim 18 wherein the phytosterols added are in the form of a composition comprising one or more free phytosterols and phytostanols (“free sterols”) and one or more esterified phytosterols and phytostanols (“esterified sterols”).

27. The food product of claim 26 wherein the composition comprises at least 10% (by weight) free sterols.

28. The food product of claim 26 wherein the composition comprises between 10-90% by weight of free sterols.

29. The food product of claim 26 wherein the composition comprises tree sterols and esterified sterols in a ratio of about 1:1.

30. A method of reducing the microbial contamination of a particulate food material comprises mixing into or forming said food material with an effective amount of one or more phytosterols, phytostanols, or mixtures thereof.

31. The method of claim 30 wherein said particulate food material is ground meat.

32. The method of claim 30 wherein said ground meat is beef.

33. The method of claim 30 wherein said ground meat is pork.

34. The method of claim 30 wherein the phytosterols added are in the form of a composition comprising one or more free phytostanols and phytostanols (“free sterols”) and one or more esterified phytosterols and phytostanols (“esterified sterols”).

35. The method of claim 34 wherein the composition comprises at least 10% (by weight) free sterols.

36. A prepared food product comprising one or more phytsterols, phytostanols or mixtures of both, wherein said food product, after the processing steps to prepare the product and during storage before consumption, contains a reduced number of pathogenic and/or spoilage microbes as compared to the same food product without phytosterols and/or phytostanols.

37. The food product of claim 36 wherein the microbe is selected from the group consisting of bacteria, viruses, fungi and yeasts.
